(19) United States
(12) Patent Application Publication
(10) Pub. No.: US 2017/0178685 A1
(43) Pub. Date: Jun. 22, 2017

(54) Method for intercepting video animation and electronic device

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Zhinan ZHANG, Beijing (CN)

(21) Appl. No.: 15/242,145

(22) Filed: Aug. 19, 2016

Related U.S. Application Data
(63) Continuation of application No. PCT/CN2016/088646, filed on Jul. 5, 2016.

(30) Foreign Application Priority Data
Dec. 22, 2015 (CN) 2015109715216

(51) Int. Cl. G11B 27/031; H04N 21/44; H04N 21/854; G11B 27/10; H04N 21/472

(52) U.S. Cl. CPC G11B 27/031; G11B 27/10; H04N 21/47205; H04N 21/854; H04N 21/44008

(57) ABSTRACT

Disclosed are a method and an electronic device for capturing a video animation. The method includes: receiving a video animation capture instruction; obtaining an image frame set corresponding to a video being played, and capturing image frames within a preset range from the said image frame set; and generating a video animation according to the said image frames within the preset range.

### CROSS REFERENCE TO RELATED APPLICATIONS

The present application is a continuation of PCT application which has an application number of PCT/CN2016/088646 and was filed on Jul. 5, 2016. This application is based upon and claims priority to Chinese Patent Application NO. 201510971521.6, filed on Dec. 22, 2015 with the State Intellectual Property Office of People's Republic of China, the entire contents of which are incorporated herein by reference.

### TECHNICAL FIELD

The present application relates to the technical field of network communication, and in particular to a method and an electronic device for capturing a video animation.

### BACKGROUND

Presently, in watching a video, if a user is interested in contents of a certain frame of video image, a corresponding image may be obtained by capturing the video content. A capture function may be achieved by operating a combination pre-configured on hardware such as a mobile device of keys for capturing, but effect is not ideal.

In view of this, a button with a capturing function is added onto a full-screen playing window of a part of mobile terminal video application software, such that the user may conveniently share a wonderful video. When capturing by a capture button of the video application software, only the button with the capturing function is clicked on the full-screen playing window, content of a single image played in a current video can be obtained and viewed quickly, thereby facilitating sharing and collecting the content of the video quickly by the user. In this way, the video content being currently played can be captured conveniently and quickly without capturing using the key combination of the device hardware itself, thereby avoiding switching between two software when the user captures and views a capture result.

However, the existing part of mobile terminal video application software has a single capturing function and only supports capturing a single image from the video being currently watched. If the user wants to acquire video content of continuous short frames which is been currently played, it cannot be achieved by the method. It follows that, with the capturing method in the prior art, a video animation can not be generated automatically according to the current played video content, and a requirement of obtaining dynamic pictures by a user can not be met.

### SUMMARY

In view of the above problems, a method and an electronic device for capturing a video animation are provided according to the disclosure, to solve the above problems.

According to an aspect of the disclosure, a method for capturing a video animation is provided, which includes: receiving a video animation capture instruction; obtaining an image frame set corresponding to a video being played and capturing image frames within a preset range from the said image frame set; and generating a video animation according to the image frames within the preset range.

According to another aspect of the disclosure, an electronic device is provided, which includes: at least one processor; and a storage device communicably connected with the said at least one processor; wherein, the said storage device stores instructions executable by the said at least one processor, the said instructions are configured for: receiving a video animation capture instruction; obtaining an image frame set corresponding to a video being played, and capturing image frames within a preset range from the said image frame set; and generating a video animation according to the said image frames within the preset range.

In another aspect of an embodiment of the present disclosure, a non-transitory computer-readable storage medium, wherein the said non-transitory computer-readable storage medium can store computer-executable instructions, the said computer-executable instructions are configured for: receiving a video animation capture instruction; obtaining an image frame set corresponding to a video being played, and capturing image frames within a preset range from the said image frame set; and generating a video animation according to the said image frames within the preset range.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a flow chart of a method for capturing a video animation in accordance with an embodiment of the disclosure;

FIG. 2 illustrates a flow chart of a method for capturing a video animation in accordance with an embodiment of the disclosure;

FIG. 3a illustrates a schematic diagram of an screenshot capture gateway;

FIG. 3b illustrates a schematic diagram of popup items displayed by way of a floating layer;

FIG. 3c illustrates a schematic diagram of an interface after execution of step S230 is complete;

FIG. 3d illustrates a schematic diagram when modification is being made according to an instruction for modification of pictures;

FIG. 3e illustrates a schematic diagram when editing is being performed according to the duration edit instruction;

FIG. 3f illustrates a schematic diagram of a published video page;

FIG. 3g illustrates a schematic diagram of a half-screen video playing page;

FIG. 4 illustrates a flow chart of a method for capturing a video animation in accordance with another embodiment of the disclosure;

FIG. 5a illustrates a schematic diagram of an interface for triggering a video animation capture instruction;

FIG. 5b illustrates a schematic diagram of an interface when it is edited by a picture axis;

FIG. 5c illustrates a schematic diagram of an interface when it is edited by a time axis;

FIG. 6 illustrates a structural diagram of a device for capturing a video animation in accordance with an embodiment of the disclosure; and

FIG. 7 schematically illustrates the hardware structure of the electronic device configured for executing the method for capturing a video animation according to another embodiment of the disclosure.

### DETAILED DESCRIPTION

Hereinafter exemplary embodiments of the disclosure are described in detail with reference to the drawings. Although the drawings show the exemplary embodiments of the disclosure, it should be understood that the disclosure may be implemented in various forms and is not limited by the embodiments clarified here. In contrast, the embodiments are provided such that the disclosure can be understood more thoroughly and the scope of the disclosure can be conveyed fully to those skilled in the art.

A method and an electronic device for capturing a video animation are provided according to embodiments of the disclosure, which can at least solve the technical problem that the conventional application software has a single capture function, only supports to capture a single image from a video being currently watched, and cannot generate a video animation automatically according to the video content being currently played, thereby not satisfying a requirement of obtaining dynamic pictures by a user.

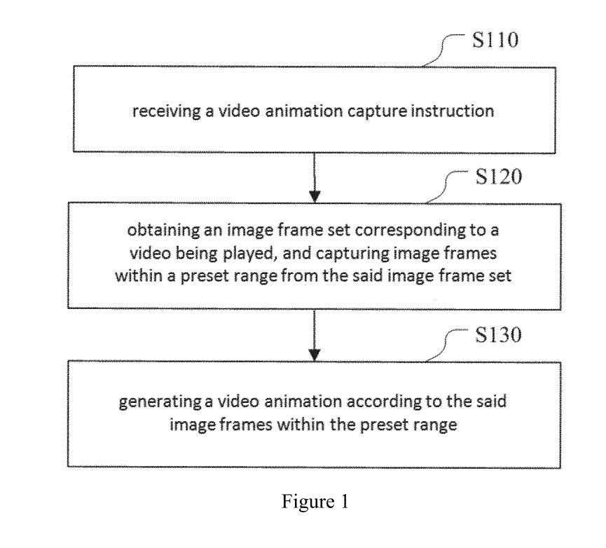

FIG. 1 illustrates a flow chart of a method for capturing a video animation in accordance with an embodiment of the disclosure. As shown in FIG. 1, the method includes the following steps:

Step S110: receiving a video animation capture instruction.

Optionally, the video animation capture instruction may be received via a screenshot capture gateway provided by a video application. The screenshot capture gateway may be realized by a virtual icon or button on a full-screen display interface of the video application. When the virtual icon or button is clicked, the video animation capture instruction is triggered.

Step S120: obtaining an image frame set corresponding to a video being played, and capturing image frames within a preset range from the said image frame set.

All image frames of the video being played are stored in the image frame set in a chronological order corresponding to the video being played. Accordingly the said capturing image frames within a preset range from the said image frame set comprises: determining a image, which is being currently displayed, of the video being played when the said video animation capture instruction is received; and capturing image frames adjacent to the said image being currently displayed from the said image frame set within a preset time period.

Step S130: generating a video animation according to the said image frames within the preset range.

Specifically, the step may be implemented by either one of the following two ways:

In a first embodiment, a customization editing instruction is received, and the image frames within the preset range are processed according to the customization editing instruction, to generate a corresponding video animation. The customization editing instruction includes an image edit instruction and/or the duration edit instruction. The image edit instruction includes a first frame image and a last frame image; when the image edit instruction is received, image frames within a subinterval defined by the first frame image and the last frame image are extracted from the image frames within the preset range, and a corresponding video animation is generated according to the image frames within the subinterval. The duration edit instruction includes length of time; when the duration edit instruction is received, frame extraction is performed according to the length of time to generate a corresponding video animation.

In a second embodiment, the video animation capture instruction received in step S110 further includes duration information. Hence, it is not necessary to receive the customization editing instruction; frame extraction is performed on the image frames within the preset range directly according to the duration information included in the video animation capture instruction, to obtain a video animation conforming to the duration information.

The above two embodiments may be used independently or in combination. Those skilled in the art may flexibly generate the video animation by various ways. For example, a video animation may be produced directly from the image frames within a preset range, which is not limited in the disclosure.

It follows that, with the disclosure, the image frames within the preset range can be captured automatically according to the received video animation capture instruction and a corresponding video animation is to be generated, which will satisfy users' demands for obtaining dynamic pictures.

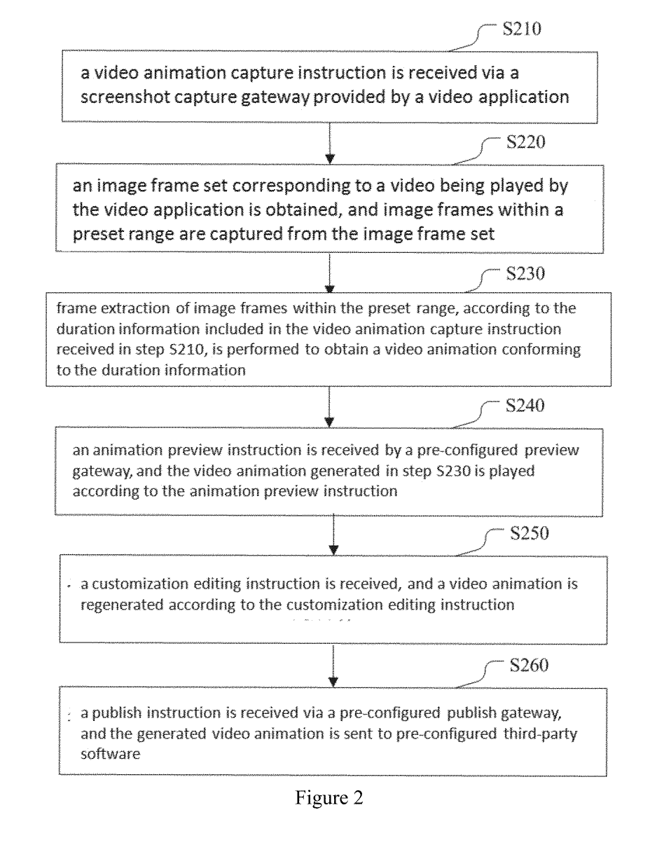

FIG. 2 illustrates a flow chart of a method for capturing a video animation in accordance with an embodiment of the disclosure. As shown in FIG. 2, the method includes the following steps:

In step S210, a video animation capture instruction is received via a screenshot capture gateway provided by a video application.

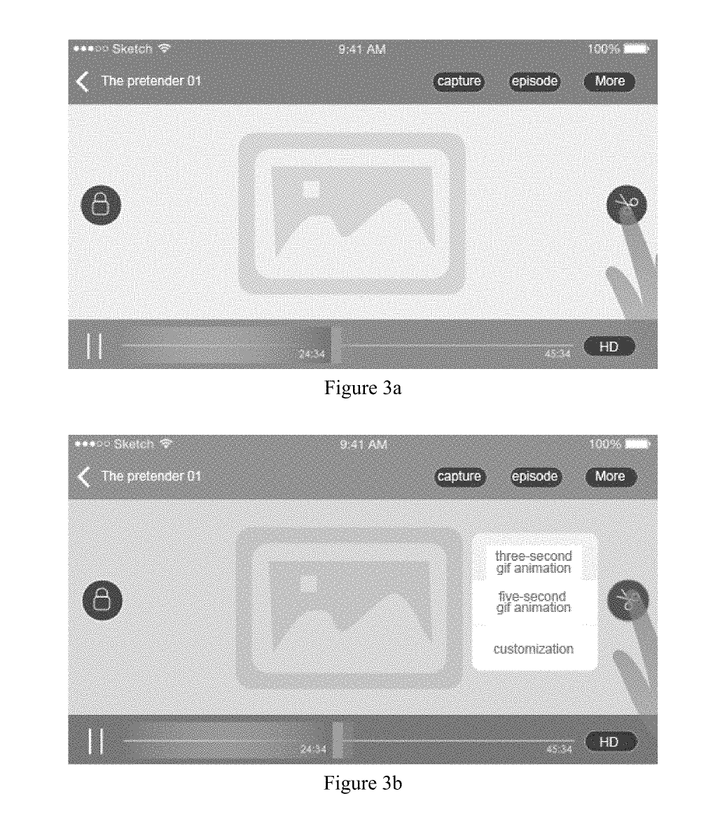

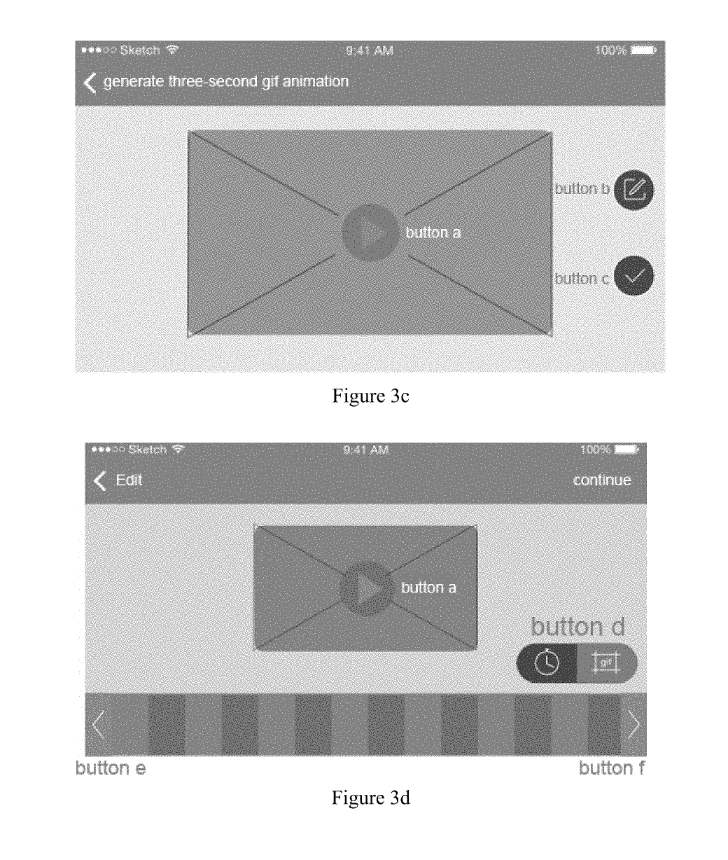

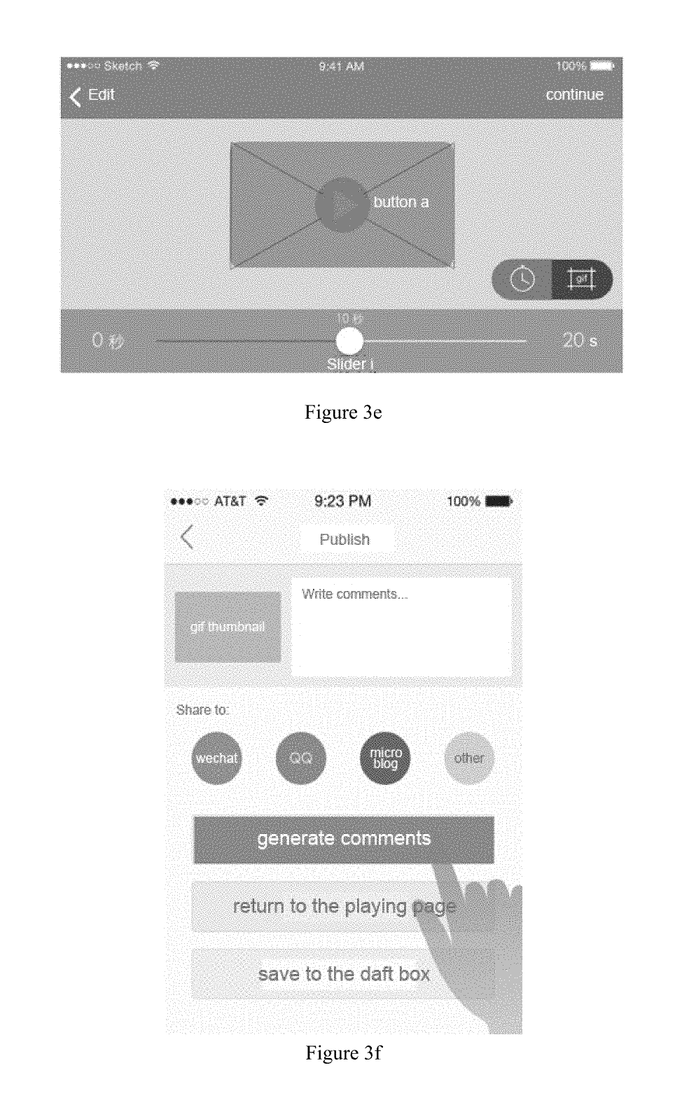

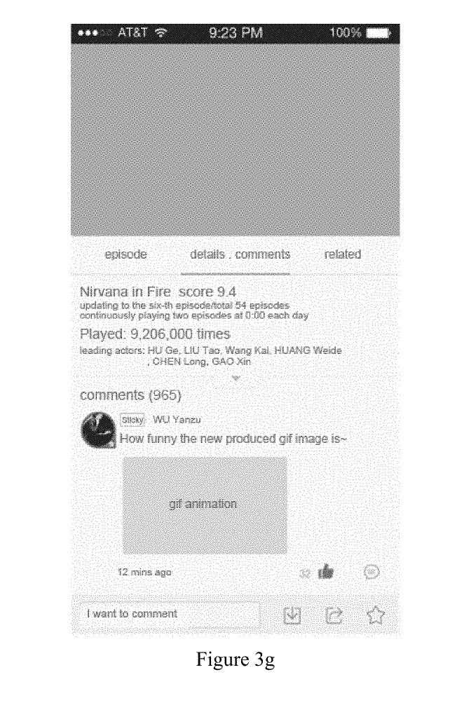

FIG. 3a illustrates a schematic diagram of a screenshot capture gateway. It may be seen from FIG. 3a that, the screenshot capture gateway is a scissors-shaped icon. In the embodiment, the screenshot capture gateway can detect length of time or strength of a touch-control input amount by a user, and perform different processes according to the length of time or strength of the touch-control input amount. For example, where the duration or strength of the users' touch-control input amount which is detected by the screenshot capture gateway is less than a preset threshold, a single-image capture instruction is triggered, and a frame of static image of current video content is directly captured. Where the duration or strength of the users' touch-control input amount which is detected by the screenshot capture gateway is greater than the preset threshold, the video animation capture instruction is triggered. Hence, two different types of instruction can be received via one screenshot capture gateway, such that a display interface of the video application is simpler and more user-friendly.

Specifically, where the duration or strength of the users' touch-control input amount which is detected by the screenshot capture gateway is greater than the preset threshold, popup items displayed in a floating layer pop up on the interface of the video application. FIG. 3b illustrates a schematic diagram of popup items displayed in a floating layer. It may be seen from FIG. 3b that, the following three items are provided in the popup items: three-second gif animation, five-second gif animation and customization. In the embodiment, the first two items are mainly introduced, and the third item is introduced in detail in another embodiment.

When the user selects the item of three-second gif animation or five-second gif animation, a video animation capture instruction is triggered, which includes information of length of time (i.e., 3 seconds or 5 seconds) selected by the user.

In addition, in other embodiments of the disclosure, the video animation capture instruction may be triggered by other ways, for example, being trigged by preset shortcut keys.

In step S220, an image frame set corresponding to a video being played by the video application is obtained, and image frames within a preset range are captured from the image frame set.

All image frames of the video being played are stored in the image frame set in a chronological order corresponding to the video being played of the video application. For example, it is assumed that the video being played is a movie entitled “The pretender”, the duration of playing the movie is 45 minutes and 34 seconds, and the frame rate of this video is 24 frames per second. Hence, 24*(45 minutes and 34 seconds)=65616 frames of image are stored in the image frame set in the chronological order corresponding to the video being played by the video application.

Accordingly, ways of realizing the capturing image frames within a preset range from the image frame set consisting of 65616 frames of images include: determining a image, which is being currently displayed, of the video being played when the said video animation capture instruction is received, and capturing image frames adjacent to the said image being currently displayed from the said image frame set within a preset time period. For example, in the embodiment, it is assumed that the currently displayed image of the video being played is an image corresponding to the 20^{th} minute when the video animation capture instruction is received, and image frames corresponding to the time range of 10 seconds before the image to 10 seconds after the image may be captured, i.e., 480 frames of images corresponding to the time range of 19 minutes 50 seconds to 20 minutes 10 seconds. Those skilled in the art may flexibly adjust the range of the captured image frames. For example, image frames corresponding to a time range of 30 seconds before the current image or 30 seconds after the current image may be captured, and the specific time range may be set according to actual cases, which is not limited in the disclosure.

In step S230, frame extraction of image frames within the preset range, according to the duration information included in the video animation capture instruction received in step S210. is performed to obtain a video animation conforming to the duration information.

For example, it is assumed that the duration information included in the video animation capture instruction received in step S210 is 5 seconds, frame extraction is performed on the 480 frames of image captured in step S220 using a preset frame extraction algorithm, to obtain a video animation of which the duration is 5 seconds. Specifically, the frame extraction algorithm is: extracting, in the 480 frames of images, one frame from every two frames, to obtain the number of image frames after one round of frame extraction; determining whether the number of image frames after the round of frame extraction matches the duration of 5 seconds; and where the number of image frames does not match the duration of 5 seconds, extracting one frame out of every two frames again until the number of image frames after the frame extraction process matches the duration of 5 seconds. Alternatively, a process of extracting one frame out of every three frames or extracting two frames out of every three frames may be performed circularly, until the number of processed image frames matches the duration of 5 seconds. Whether the number of image frames matches the duration of 5 seconds is mainly determined by a predetermined frame rate of the video animation. For example, the predetermined frame rate of the video animation may be set within the range of 20-30 frames per second, and the number of image frames is determined to have matched the duration once the frame rate falls within the range.

In step S240, an animation preview instruction is received by a pre-configured preview gateway, and the video animation generated in step S230 is played according to the animation preview instruction.

Step S240 is optional. FIG. 3c illustrates a schematic diagram of an interface when execution of step S230 is complete. A button “a” in the middle of FIG. 3c is the pre-configured preview gateway. An animation preview instruction sent by the user can be received by the preview gateway, and the video animation generated in step S230 is played when the animation preview instruction is received, such that the user can preview an outcome of the video animation.

In step S250, a customization editing instruction is received, and a video animation is regenerated according to the customization editing instruction.

Step S250 is also optional. Where the user is not satisfied with the outcome of the video animation generated in step S230, it may be modified by the customization editing instruction. A button “b” located on an upper right side of FIG. 3c can receive the customization editing instruction sent by the user. When the user clicks the button “b”, the page jumps to a page as shown in FIG. 3d or FIG. 3e. The customization editing instruction further includes an image edit instruction and/or the duration edit instruction.

FIG. 3d illustrates a schematic diagram when modification is performed according to an image edit instruction. A picture axis is provided at the bottom of FIG. 3d. The image frames (480 frames of images) within a preset range captured in step S220 are shown in the picture axis in a chronological order. A user may set a first frame image of the edited video animation by dragging a slider “e” in FIG. 3d and set a last frame image of the edited video animation by dragging a slider “f” in FIG. 3d, such that a subinterval defined by the first frame image and the last frame image is generated among the image frames within the preset range, and a video animation is regenerated according to images within the subinterval. It follows that, the number of frames of images within the preset range captured in step S220 can be reduced by virtue of the image edit instruction, thereby discarding video frames of which the user is of no interest.

FIG. 3e illustrates a schematic diagram when modification is performed according to the duration edit instruction. A time axis is provided at the bottom of FIG. 3e, a time range displayed by the time axis is 20 seconds (the time range depends on length of the preset time period in step S210). A user may set the duration of the edited video animation by dragging a slider “j” in FIG. 3e, for example, changing the duration of the video animation from 5 seconds to 10 seconds. Specifically, frame extraction is performed on the image frames according to a preset frame extraction algorithm, to obtain a video animation which matches the duration of 10 seconds. It follows that, the duration of the video animation generated in step S230 can be modified by the duration edit instruction.

The duration edit instruction shown in FIG. 3e and the image edit instruction shown in FIG. 3d can be switched by the button “d” shown in the figures. The duration edit instruction and the image edit instruction may be used independently or in combination.

In step S260: a publish instruction is received via a pre-configured publish gateway, and the generated video animation is sent to pre-configured third-party software.

Step S260 is optional. A button “c” shown in FIG. 3c, and an icon of “continue” shown in FIG. 3d and FIG. 3e may function as a publish gateway. When the user clicks the publish gateway, it jumps to a publish page as shown in FIG. 3f. In that page, the user may send the generated video animation to pre-configured third-party software, for example WeChat, QQ and Microblog. In the page, the user may input comments or elaborations about the video animation via a text input window. The user may publish the generated video animation picture to a third-party social circle by clicking the button of “generate comments”. If the user clicks a button of “return to the playing page”, it jumps to a half-screen video playing page shown in FIG. 3g. In the half-screen video playing page, the user may preview a video animation to be delivered to the third-party social circle. In addition, the user may store the video animation in a local storage device.

The order of the above-described steps in the embodiment may be adjusted flexibly, and the steps may be combined for less or be divided for more.

It follows that, in the embodiment, a video animation can be generated quickly by selecting the option of three-second or five-second (those skilled in the art may vary the default duration), thereby satisfying users' demands that a video animation is generated conveniently and quickly while watching a video. After previewing the current generated animation, the user may change the video animation, thereby fulfilling more of the users' demands.

In addition, it is described by reference to capturing a video animation in a video application in the above embodiments, where the video application is mainly used to play on-line video contents. In other embodiments of the disclosure, the above methods may be applied to other types of player-kind software, for example applying to a player for playing video files stored in a local hard disk of a computer, and a specific scene of application is not limited in the disclosure.

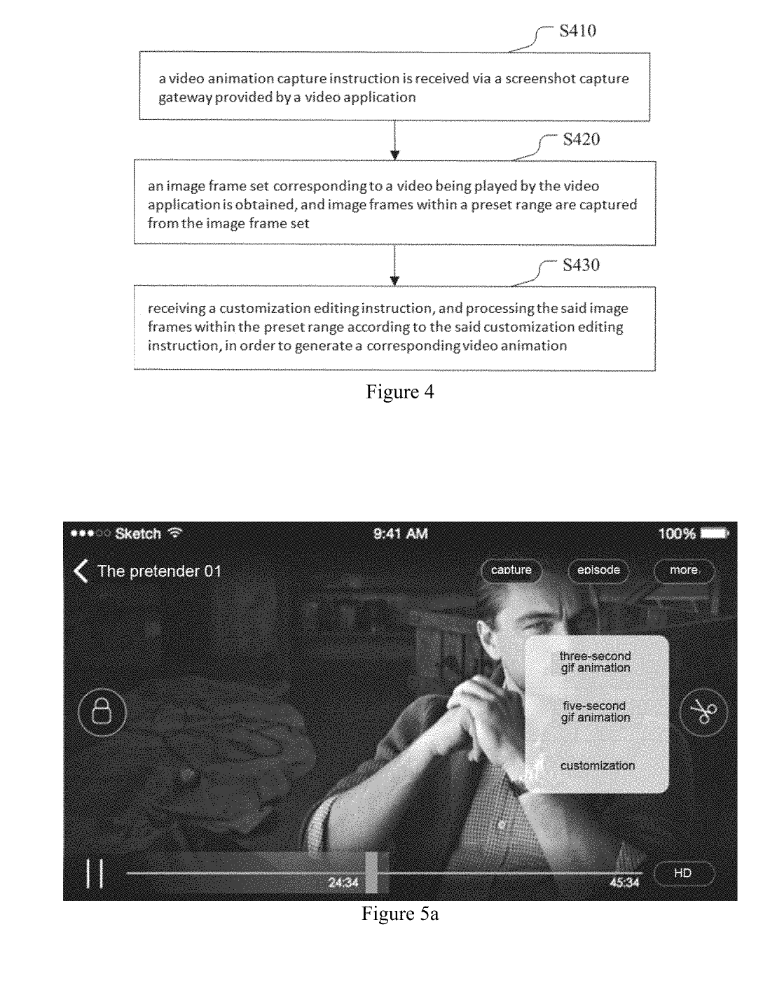

FIG. 4 illustrates a flow chart of a method for capturing a video animation in accordance with another embodiment of the disclosure. As shown in FIG. 4, the method may the following steps:

In step S710, a video animation capture instruction is received via a screenshot capture gateway provided by the video application.

An embodiment of step S710 may make reference to step S210 in the last embodiment. FIG. 3a illustrates a schematic diagram of a screenshot capture gateway. FIG. 3b shows a schematic diagram of popup items displayed in a floating layer. It may be seen from FIG. 3b that, the following three items are provided in the popup items: three-second gif animation, five-second gif animation and customization. The first two items are described in the last embodiment, and the third item is mainly described in this embodiment. Where a user selects the customization item, subsequent S720 and step S730 are triggered.

In step S720, an image frame set corresponding to a video being played of the video application is obtained, and image frames within a preset range are captured from the image frame set.

All image frames of the video being played are stored in the image frame set in a chronological order corresponding to the video being played by the video application. For example. it is assumed that the video being played is a movie titled “The pretender”, the duration of the movie is 45 minutes and 34 seconds, and the frame rate of the video is 24 frames per second. Therefore, 24*(45 minutes 34 seconds)=65616 frames of images are stored in the image frame set in the chronological order corresponding to the video being played of the video application. Accordingly, ways of realizing the capturing image frames within a preset range from the image frame set consisting of 65616 frames of images include: determining a image, which is being currently displayed, of the video being played when the said video animation capture instruction is received, and capturing image frames adjacent to the said image being currently displayed from the said image frame set within a preset time period. For example, in the embodiment, it is assumed that the currently displayed image of the video being played is an image corresponding to the 20^{th} minute when the video animation capture instruction is received, and image frames corresponding to the time range of 10 seconds before the image to 10 seconds after the image may be captured, i.e., 480 frames of images corresponding to the time range of 19 minutes 50 seconds to 20 minutes 10 seconds. Those skilled in the art may flexibly adjust the range of the captured image frames. For example, image frames corresponding to a time range of 30 seconds before the current image or 30 seconds after the current image may be captured, and the specific time range may be set according to actual cases, which is not limited in the disclosure.

In step S730, a customization editing instruction is received, and the image frames within the preset range are processed according to the customization editing instruction, to generate a corresponding video animation.

Specifically, when a user selects the customization item in FIG. 3b, the application interface jumps to a custom editing interface shown in FIG. 3d or FIG. 3e. The customization editing instruction further includes an image edit instruction and/or the duration edit instruction. FIG. 3d illustrates a schematic diagram when it is edited according to the image edit instruction. A picture axis is provided at the bottom of FIG. 3d, and the picture axis shows image frames within the preset range (i.e. 480 frames of image) captured in step S720 in a chronological order. The user may set a first frame image of the video animation by dragging a slider “e” in FIG. 3d, and set a last frame image of the video animation by dragging a slider “f” in FIG. 3d, such that a subinterval defined by the first frame image and the last frame image is generated among the image frames within a preset range, and a video animation is generated according to images within the subinterval. It follows that, the number of frames of image within the preset range captured in step S720 can be reduced by the image edit instruction, thereby discarding video frames which the user does not need.

FIG. 3e illustrates a schematic diagram when modification is performed according to the duration edit instruction. A time axis is provided at the bottom of FIG. 3e, a time range displayed by the time axis is 20 seconds. A user may set the duration of the video animation by dragging a slider in FIG. 3e, for example, setting the duration of the video animation as 10 seconds. Specifically, frame extraction is performed on the image frames by a preset frame extraction algorithm, to obtain a video animation matching the duration of 10 seconds. It follows that the duration of the video animation can be set by the duration edit instruction.

The duration edit instruction shown in FIG. 3e and the image edit instruction shown in FIG. 3d can be switched by the button d shown in the figures. The duration edit instruction and the image edit instruction may be used independently or in combination.

It follows that, in the embodiment, it can directly proceed to video animation editing step by the customization item, thereby editing animation content by which the user is satisfied. Where the user is not satisfied with the video animation of 3 seconds or 5 seconds generated by the video application by default, the user may flexibly set the duration of the video animation and the range of the first frame to the last frame using the ways provided by the embodiment, thereby directly generating a video animation which automatically satisfies the user.

In addition, the embodiment may further include part of the steps from the last embodiment, for example previewing and publishing.

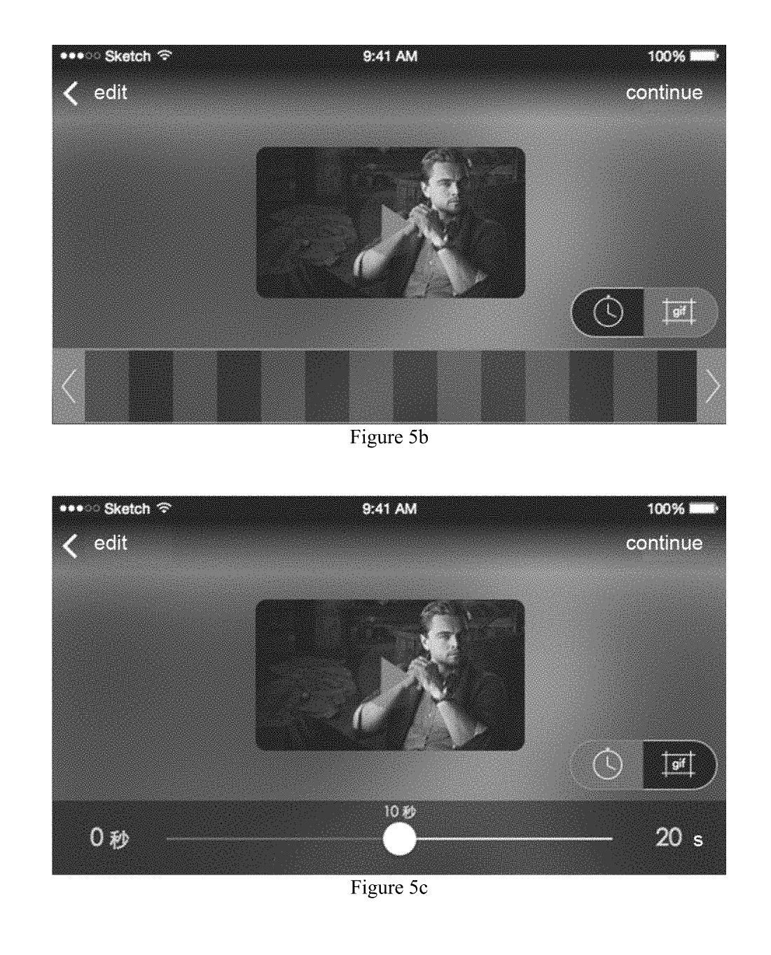

In order to make the disclosure to be understood more intuitively, FIG. 5a-5c illustrate schematic diagrams of an interface of the method in accordance with the disclosure by an embodiment. FIG. 5a illustrates a schematic diagram of an interface when a video animation capture instruction is triggered, FIG. 5b illustrates a schematic diagram of an interface when it is edited by a picture axis, and FIG. 5c illustrates a schematic diagram of an interface when it is edited by a time axis.

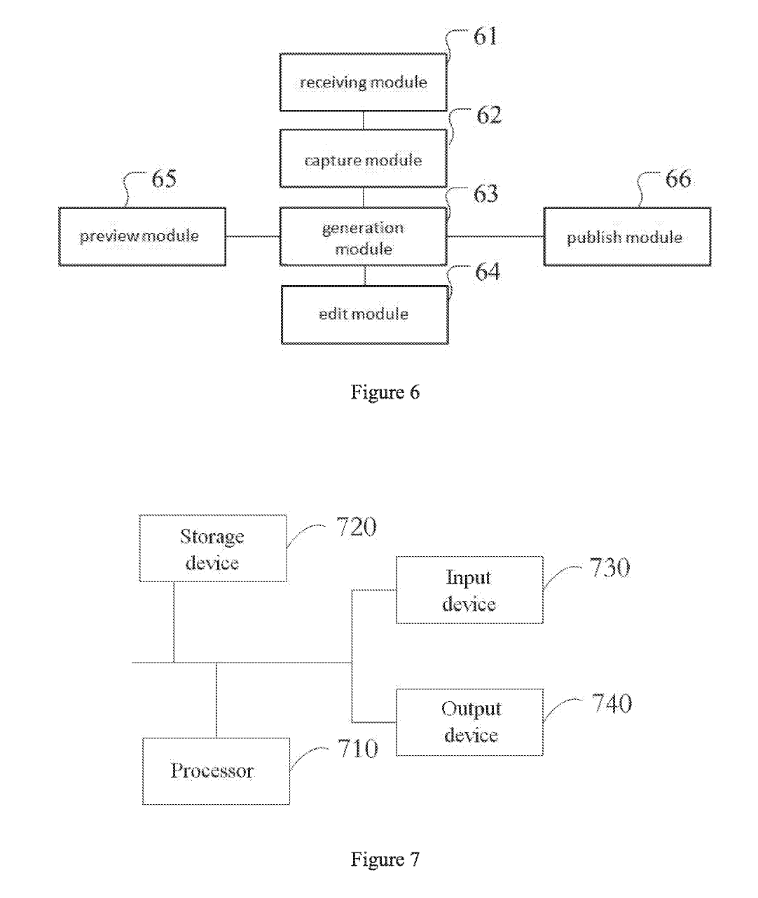

FIG. 6 illustrates a schematic structural diagram of a device for capturing a video animation. As shown in FIG. 6, the device includes:

a receiving module 61 configured to receive a video animation capture instruction;

a capture module 62 configured to obtain an image frame set corresponding to a video being played and capture image frames within a preset range from the said image frame set;

a generation module 63 configured to generate a video animation according to the said image frames within the preset range.

All image frames of the video being played are stored in the image frame set in a chronological order corresponding to the video being played of the video application. The capture module 62 is configured to determine a image, which is being currently displayed, of the video being played when the said video animation capture instruction is received; and capture image frames adjacent to the said image being currently displayed from the said image frame set within a preset time period.

In an embodiment, the generation module 63 is configured to receive a customization editing instruction, and process the image frames within the preset range according to the customization editing instruction, to generate a corresponding video animation, wherein the said customization editing instruction includes an image edit instruction and/or the duration edit instruction, and said the image edit instruction includes a first frame image and a last frame image. When the said image edit instruction is received, image frames within a subinterval defined by the said first frame image and the said last frame image are extracted from the said image frames within the preset range, and a corresponding video animation is generated according to the said image frames within the subinterval. The said duration edit instruction includes length of time; when the duration edit instruction is received, frame extraction is performed according to the length of time to generate a corresponding video animation.

In another embodiment, the generation module 63 is configured to perform frame extraction on the image frames within the preset range according to the duration information included in the video animation capture instruction, to obtain a video animation conforming to the duration information.

Optionally, the device may further include: an edit module 64 configured to receive a customization editing instruction and regenerate a video animation according to the customization editing instruction. The said customization editing instruction includes an image edit instruction and/or the duration edit instruction, and the image edit instruction includes a first frame image and a last frame image. When the image edit instruction is received, image frames within a subinterval defined by the first frame image and the last frame image are extracted from the image frames within the preset range, and a video animation is regenerated according to the image frames within the subinterval. The duration edit instruction includes the length of time; when the duration edit instruction is received, frame extraction is performed according to the length of time to regenerate the video animation.

Optionally, the device may further include a preview module 65 configured to receive an animation preview instruction via a pre-configured preview gateway, and play the video animation according to the animation preview instruction.

Optionally, the device may further include: a publish module 66 configured to receive a publish instruction via a pre-configured publish gateway and send the generated video animation to pre-configured third-party software.

In the method and device according to the disclosure for capturing a video animation in a video application, the video animation capture instruction can be received via the screenshot capture gateway provided by the video application, the image frame set corresponding to the video being played of the video application is obtained, and the image frames within a preset range are captured from the image frame set, to generate a corresponding video animation. It follows that, with the disclosure, the image frames within the preset range can be captured automatically according to the received video animation capture instruction and the corresponding video animation is generated, thereby satisfying users' demands for obtaining dynamic pictures.

A non-transitory computer-readable storage medium, wherein the said non-transitory computer-readable storage medium can store computer-executable instructions, is provided according to an embodiment of the present disclosure, and the said computer-executable instructions are configured to execute any one of the said methods of embodiments of the present application for executing the method for capturing a video animation according to the disclosure.

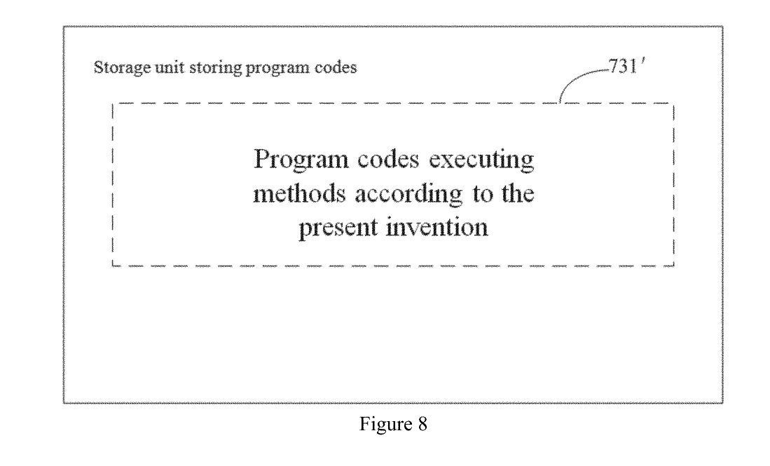

FIG. 7 illustrates the hardware structure of the electronic device configured for executing the method for capturing a video animation according to the disclosure. As shown in FIG. 7, the said electronic device comprises:

one processor 710, which is shown in FIG. 4 as an example, or more processors and a storage device 720;

the electronic device executing the method for capturing a video animation further comprises: an input device 730 and an output device 740.

The processor 710, storage device 720, input device 730 and output device 740 can be connected by BUS or other methods, and BUS connecting is shown in FIG. 7 as an example.

Storage device 720 can be used for storing non-transitory software program, non-transitory computer executable program and modules as a non-transitory computer-readable storage medium, such as corresponding program instructions/modules for executing the methods for capturing a video animation mentioned by embodiments of the present disclosure (for example, as shown in FIG. 6, a receiving module 61, a capture module 62, a generation module 63 and so on). Processor 710 by executing non-transitory software program performs all kinds of functions of a server and process data, instructions and modules which are stored in storage device 720, thereby realizes the methods for capturing a video animation mentioned by embodiments of the present disclosure.

Storage device 720 can include program storage area and data storage area, thereby the operating system and applications required by at least one function can be stored in program storage area and data created by using the device. Furthermore, storage device 720 can include high speed Random-access memory (RAM) or non-volatile memory such as hard drive storage device, flash memory device or other non-volatile solid state storage devices. In some embodiments, storage device 720 can include long-distance setup memories relative to processor 710, which can communicate via network with the device for realizing the methods mentioned by embodiments of the present disclosure. The examples of said networks are including but not limited to Internet, Intranet, LAN, mobile Internet and their combinations.

Input device 730 can be used to receive inputted number, character information and key signals causing user configures and function controls of the device. Output device 740 can include a display screen or a display device.

The said module or modules are stored in storage device 720 and perform any one of the methods for capturing a video animation when executed by one or more processors 710.

The said device can achieve the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smart phones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability. manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a hard drive, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-10 (canceled)

11. A method, which is applied to a terminal, for capturing a video animation, comprising:
receiving a video animation capture instruction;
obtaining an image frame set corresponding to a video being played, and capturing image frames within a preset range from the said image frame set; and
generating a video animation according to the said image frames within the preset range.

12. The method according to claim 11, wherein all image frames of the video being played are stored in the image frame set in a chronological order corresponding to the video being played;
and the said capturing image frames within a preset range from the said image frame set comprises: determining a image, which is being currently displayed, of the video being played when the said video animation capture instruction is received; and capturing image frames adjacent to the said image being currently displayed from the said image frame set within a preset time period.

13. The method according to claim 11, wherein the said generating a video animation according to the said image frames within the preset range comprises: further receiving a customization editing instruction, and processing the said image frames within the preset range according to the said customization editing instruction, in order to generate a corresponding video animation;
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is generated according to the image frames within the said subinterval; and the duration edit instruction includes length of time, and when the duration edit instruction is received, frame extraction is performed according to the said length of time to generate a corresponding video animation.

14. The method according to claim 11, wherein the said generating a video animation according to image frames within the preset range comprises:
performing frame extraction on the image frames within the preset range according to duration information included in the said video animation capture instruction, to obtain a video animation conforming to the duration information.

15. The method according to claim 14, wherein after generating a video animation, the method further comprises: receiving a customization editing instruction, and regenerating a video animation according to the said customization editing instruction,
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is regenerated according to the image frames within the said subinterval; and the duration edit instruction includes length of time, and when the duration edit instruction is received, frame extraction is performed according to the said length of time to regenerate a corresponding video animation.

16. An electronic device, comprising:
at least one processor; and
a storage device communicably connected with the said at least one processor;
wherein,
the said storage device stores instructions executable by the said at least one processor, wherein execution of the instructions by the said at least one processor causes the at least one processor to:
receive a video animation capture instruction;
obtain an image frame set corresponding to a video being played, and capture image frames within a preset range from the said image frame set; and
generate a video animation according to the said image frames within the preset range.

17. The electronic device according to claim 16, wherein all image frames of the video being played are stored in the image frame set in a chronological order corresponding to the video being played,
and the said capturing image frames within a preset range from the said image frame set comprises: determining a image, which is being currently displayed, of the video being played when the said video animation capture instruction is received; and
capturing image frames adjacent to the said image being currently displayed from the said image frame set within a preset time period.

18. The electronic device according to claim 16, wherein the said generating a video animation comprises: receiving a customization editing instruction and processing the image frames within the preset range according to the customization editing instruction, to generate a corresponding video animation,
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is generated according to the image frames within the said subinterval; and the duration edit instruction includes length of time, and when the duration edit instruction is received, frame extraction is performed according to the said length of time to generate a corresponding video animation.

19. The electronic device according to claim 16, wherein the said generating a video animation comprises: performing frame extraction on the image frames within the preset range according to duration information included in the said video animation capture instruction, to obtain a video animation conforming to the duration information.

20. The electronic device according to claim 19, the said processor further execute the following steps:
receiving a customization editing instruction and regenerating a video animation according to the said customization editing instruction,
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is regenerated according to the image frames within the said subinterval; and the duration edit instruction includes length of time, and when the duration edit instruction is received, frame extraction is performed according to the said length of time to regenerate a corresponding video animation.

21. A non-transitory computer-readable storage medium, wherein the said non-transitory computer-readable storage medium can store computer-executable instructions, the said computer-executable instructions are used to:
receive a video animation capture instruction;
obtain an image frame set corresponding to a video being played, and capture image frames within a preset range from the said image frame set; and
generate a video animation according to the said image frames within the preset range.

22. The storage medium according to claim 21, wherein all image frames of the video being played are stored in the image frame set in a chronological order corresponding to the video being played;
and the said capturing image frames within a preset range from the said image frame set comprises: determining a image, which is being currently displayed, of the video being played when the said video animation capture instruction is received; and
capturing image frames adjacent to the said image being currently displayed from the said image frame set within a preset time period.

23. The storage medium according to claim 21, wherein the said generating a video animation according to the said image frames within the preset range comprises: further receiving a customization editing instruction, and processing the said image frames within the preset range according to the said customization editing instruction, in order to generate a corresponding video animation;
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is generated according to the image frames within the said subinterval; and the duration edit instruction includes length of time, and when the duration edit instruction is received, frame extraction is performed according to the said length of time to generate a corresponding video animation.

24. The storage medium according to claim 21, wherein the said generating a video animation according to image frames within the preset range comprises:
performing frame extraction on the image frames within the preset range according to duration information included in the said video animation capture instruction, to obtain a video animation conforming to the duration information.

25. The storage medium according to claim 24, wherein after generating a video animation, the method further comprises: receiving a customization editing instruction, and regenerating a video animation according to the said customization editing instruction,
wherein the said customization editing instruction comprises an image edit instruction and/or the duration edit instruction, the said image edit instruction includes a first frame image and a last frame image, and when the said image edit instruction is received, image frames within a subinterval defined by the said first frame image and the said last frame image are extracted from the image frames within the preset range, and a corresponding video animation is regenerated according to the image frames within the said subinterval; and the duration edit instruction includes length of time, and when the duration edit instruction is received, frame extraction is performed according to the said length of time to regenerate a corresponding video animation.
